(19) United States
(12) Patent Application Publication
(10) Pub. No.: US 2019/0061112 A1
(43) Pub. Date: Feb. 28, 2019

(54) RATCHET WRENCH

(71) Applicant: HAUR YUEH CO., LTD., Taichung City (TW)

(72) Inventor: Ying-Liang LAI, Taichung City (TW)

(73) Assignee: HAUR YUEH CO., LTD., Taiching City (TW)

(21) Appl. No.: 15/688,284

(22) Filed: Aug. 28, 2017

(51) Int. Cl. B25B 13/46; B25B 17/00

(52) U.S. Cl. CPC B25B 13/465; B25B 13/48; B25B 17/00; B25B 13/467

(57) ABSTRACT

A ratchet wrench includes a head shell, a handle, a ratchet wheel, a driving member, a first pawl member, a second pawl member, a first biasing member, a second biasing member, a cam member, an actuating finger, and a limiting member. The limiting member including a key slot formed in one of the actuating finger and an upper major wall of the head shell, and a key which is slidably engaged in the key slot, and which is formed in the other one of the actuating finger and the upper major wall of the head shell so as to restrict angular movement of the actuating finger.

### FIELD

The disclosure relates to a ratchet wrench, more particularly to a ratchet wrench with an actuating finger.

### BACKGROUND

With reference to FIGS. 1 to 3, a conventional ratchet wrench 1 is shown to include a handle 10, a head portion 11, a ratchet wheel 12, a pawl unit 13, and a switch unit 14. The head portion 11 has an upper wall 101, and a lower wall 102 which defines a chamber 111 together with the upper wall 101. As shown in FIG. 1, an upper surface of the upper wall 101 in proximity to the handle 10 is depressed to form a depressed region 112 with two abutment edges 114, and a through hole 113 is formed in the depressed region 112 of the upper wall 101 (see FIG. 2). The ratchet wheel 12 is rotatably mounted in the chamber 111. The pawl unit 13 has two pawl members 131 which are pivotably mounted in the chamber 111, and two biasing members 132 each of which is disposed to bias a corresponding one of the pawl members 131 to be in ratchet engagement with the ratchet wheel 12. The switch unit 14 includes a cam member 141 disposed between the pawl members 131 in the chamber 111, and an actuating finger 142 which is disposed on the upper surface of the upper wall 101, and which is coupled to the cam member 141 through the through hole 113 so as to drive the cam member 141 to turn between a first position and a second position.

As shown in FIG. 2, when the actuating finger 142 is turned in a clockwise direction to abut against one of the abutment edges 114, the cam member 141 is in pressing engagement with one of the pawl member 131 against a biasing force of a corresponding one of the biasing members 132 so as to permit the ratchet wheel 12 to rotate in a counterclockwise direction only.

As shown in FIG. 3, when the actuating finger 142 is turned in a counterclockwise direction to abut against the other one of the abutment edges 114, the cam member 141 is in pressing engagement with the other one of the pawl member 131 against a biasing force of a corresponding one of the biasing members 132 so as to permit the ratchet wheel 12 to rotate in a clockwise direction only.

As shown in FIGS. 1 and 4, the depressed region 112 is generally formed by using a stamping process, and thus, such depressed region 112 cannot be made deep enough and the depth measures no greater than 1 mm. As such, any repeated wear on the abutment edges 114 caused by frequent use of the actuating finger 142, which makes frictional contact therewith, will give rise to easy slip of an end of the actuating finger 142 out of the depressed region 112, as shown in FIG. 5.

As shown in FIG. 6, due to the easy slip of the acting finger 142 out of the depressed region 112, the cam member 141 might force both of the pawl members 131 to be disengaged from the ratchet wheel 12. As a consequence, the ratchet wrench 1 cannot function properly.

Other conventional ratchet wrenches are also disclosed by an inventor of this application in Chinese patent publication nos. 105313051 and 106553147.

### SUMMARY

Therefore, an object of the disclosure is to provide a novel ratchet wrench in which an angularly movement of an actuating finger can be effectively restricted by a limiting member.

According to a first aspect of the disclosure, a ratchet wrench includes a head shell, a ratchet wheel, a first pawl member, a first biasing member, a second pawl member, a second biasing member, a cam member, an actuating finger, and a limiting member. The head shell includes an upper major wall having a through hole, and a surrounding wall extending downwardly from a periphery of the upper major wall to define an accommodation space. The ratchet wheel is rotatably mounted in the accommodation space about a first axis, and includes a plurality of teeth angularly displaced from one another about the first axis. The first pawl member includes a first pivot end which is pivotally mounted in the accommodation space, and a first pawl end which is angularly movable between a first idle position, where the first pawl end is spaced apart from the ratchet wheel, and a first engaging position, where the first pawl end is in ratchet engagement with the ratchet wheel to permit the ratchet wheel to rotate in a clockwise direction only.

The first biasing member is disposed to bias the first pawl end to the first engaging position. The second pawl member is opposite to the first pawl member, and includes a second pivot end which is pivotally mounted in the accommodation space, and a second pawl end which is angularly movable between a second idle position, where the second pawl end is spaced apart from the ratchet wheel, and a second engaging position, where the second pawl end is in ratchet engagement with the ratchet wheel to permit the ratchet wheel to rotate in a counterclockwise direction only. The second biasing member is disposed to bias the second pawl end to the second engaging position. The cam member includes an upper end extending outwardly of the through hole, and a cam body which is disposed between the first and second pawl members, and which is pivotably mounted in the accommodation space about a second axis that is offset from and parallel to the first axis. The cam member is angularly movable about the second axis, and is configured such that when one of the first and second pawl ends is in ratchet engagement with the ratchet wheel, the other one of the first and second pawl ends is spaced apart from the ratchet wheel. The actuating finger is coupled to the upper end of the cam member to turn the cam member about the second axis. The limiting member includes a key slot formed in one of the actuating finger and the upper major wall, and a key which is slidably engaged in the key slot, and which is formed in the other one of the actuating finger and the upper major wall so as to restrict angular movement of the actuating finger.

According to a second aspect of the disclosure, a ratchet wrench includes a head shell, a handle, a ratchet wheel, a driving member, a first pawl member, a first biasing member, a second pawl member, a second biasing member, a cam member, an actuating finger, and a limiting member. The head shell includes an upper major wall and a surrounding wall. The upper major wall includes a major inner surface having a primary region which defines a first axis, and an auxiliary region which has a through hole extending along a second axis offset from and parallel to the first axis. The surrounding wall extends downwardly from a periphery of the major inner surface to define an accommodation space. The handle extends radially from the surrounding wall in proximity to the auxiliary region to terminate at a handgrip. The ratchet wheel is rotatably mounted on the primary region about the first axis in the accommodation space, and has a wheel body and a rim surface that has a plurality of teeth angularly displaced from one another about the first axis. The driving member extends downwardly from the wheel body and out of the accommodation space along the first axis to permit the ratchet wheel to rotate with the driving member about the first axis. The first pawl member is disposed on the auxiliary region in the accommodation space, and includes a first pivot end, a first pawl end, and a first abutting region. The first pivot end is pivotable about a first pivot axis offset from a reference line that is perpendicular to both the first and second axes by a predetermined distance. The first pawl end is angularly movable between a first idle position, where the first pawl end is spaced apart from the ratchet wheel, and a first engaging position, where the first pawl end is in ratchet engagement with the ratchet wheel to permit the ratchet wheel to rotate in a clockwise direction only. The first abutting region is disposed between the first pivot end and the first pawl end. The first biasing member is disposed to bias the first pawl end to the first engaging position. The second pawl member is disposed on the auxiliary region in the accommodation space, and is opposite to the first pawl member relative to the reference line. The second pawl member includes a second pivot end, a second pawl end, and a second abutting region. The second pivot end is pivotable about a second pivot axis offset from the reference line by the predetermined distance. The second pawl end is angularly movable between a second idle position, where the second pawl end is spaced apart from the ratchet wheel, and a second engaging position, where the second pawl end is in ratchet engagement with the ratchet wheel to permit the ratchet wheel to rotate in a counterclockwise direction only. The second abutting region is disposed between the second pivot end and the second pawl end. The second biasing member is disposed to bias the second pawl end to the second engaging position. The cam member includes an upper end extending outwardly of the through hole, and a cam body which is disposed between the first and second abutting regions, and which is pivotably mounted about the second axis on the auxiliary region in the accommodation space. The cam body has a camming surface, a first surface, and a second surface which are angularly displaced from one another about the second axis. Each of the first and second surfaces is offset from the second axis by a first distance. The camming surface is offset from the second axis by a second distance larger than the first distance. The cam member is angularly movable about the second axis between (i) a first position, where the camming surface is in pressing engagement with the first abutting region to force the first pawl end to the first idle position against a biasing force of the first biasing member, while the second surface confronts the second abutting region to permit the second pawl end in the second engaging position, and (ii) a second position, where the camming surface is in pressing engagement with the second abutting region to force the second pawl end to the second idle position against a biasing force of the second biasing member, while the first surface confronts the first abutting region to permit the first pawl end in the first engaging position. The actuating finger is coupled to the upper end of the cam member to turn the cam member about the second axis. The limiting member includes a key slot formed in one of the actuating finger and the upper major wall, and a key which is slidably engaged in the key slot, and which is formed in the other one of the actuating finger and the upper major wall so as to restrict angular movement of the actuating finger.

### BRIEF DESCRIPTION OF THE DRAWINGS

Other features and advantages of the disclosure will become apparent in the following detailed description of the embodiments with reference to the accompanying drawings, in which:

FIG. 1 is a perspective view of a conventional ratchet wrench;

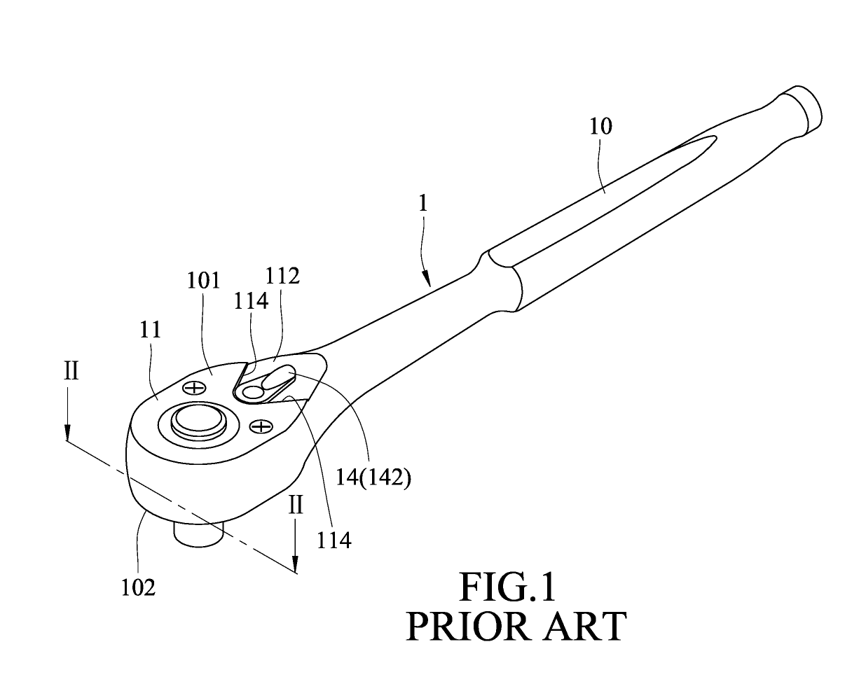

FIG. 2 is a fragmentary cross-sectional view taken along line II-II of FIG. 1, which illustrates a ratchet wheel can rotate only in a counterclockwise direction;

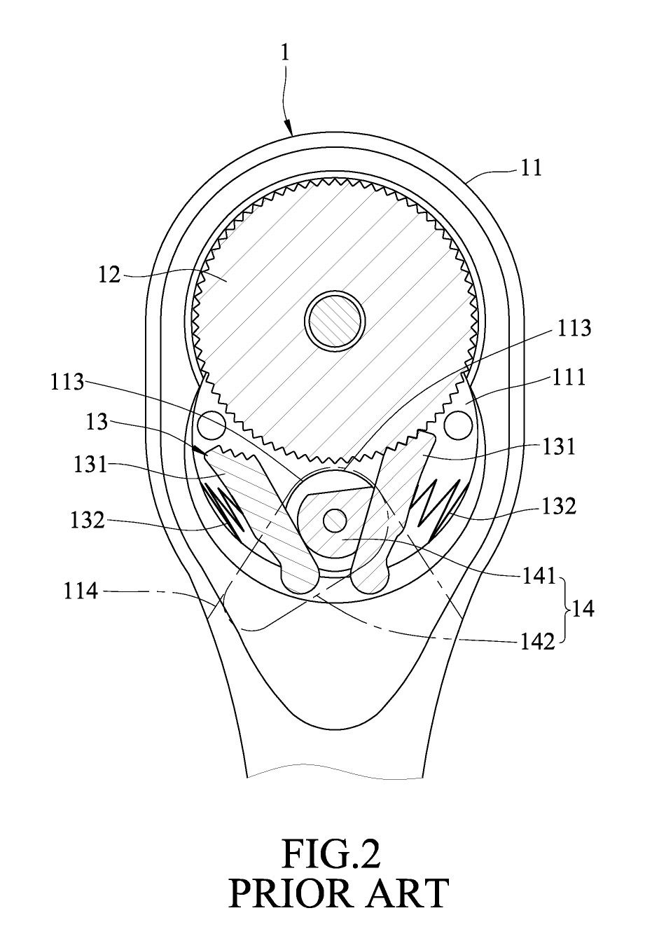

FIG. 3 is similar to FIG. 2 but illustrating the ratchet wheel can rotate only in a clockwise direction;

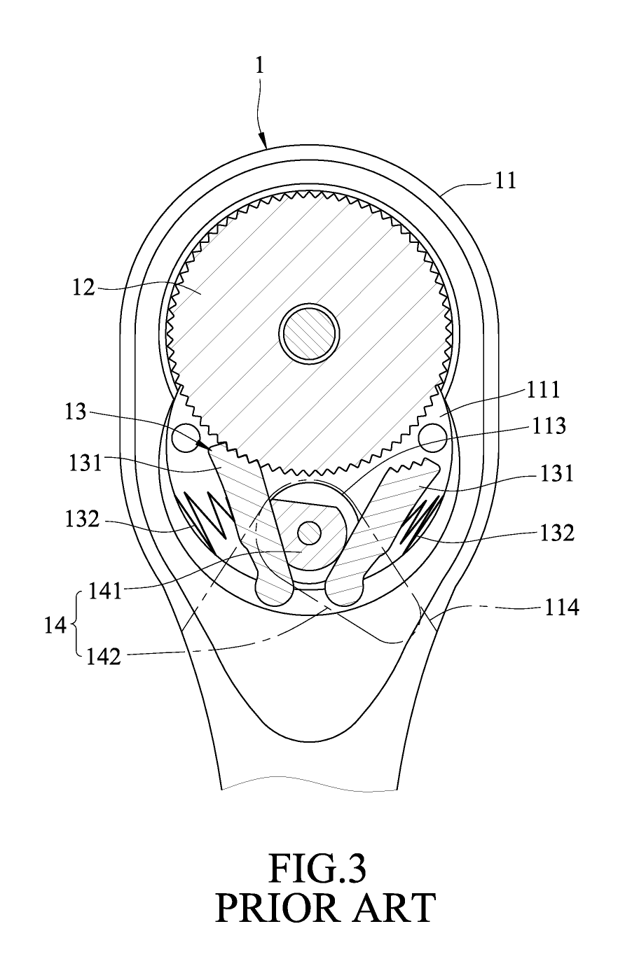

FIG. 4 is a fragmentary transverse cross-sectional view of the conventional ratchet wrench;

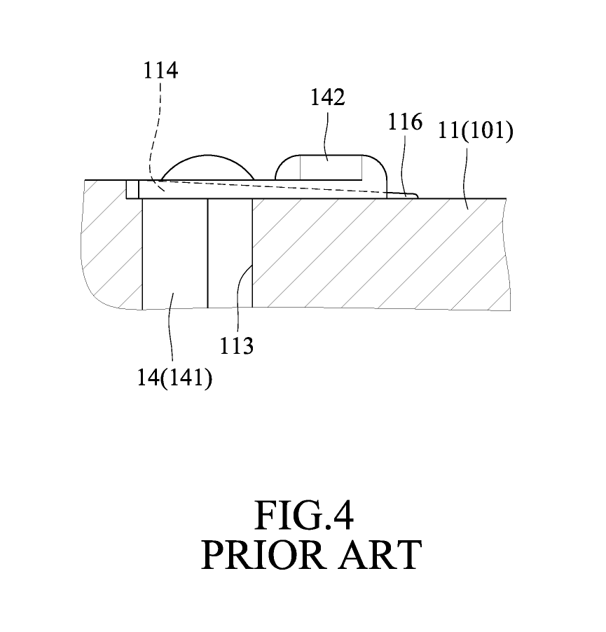

FIG. 5 is similar to FIG. 1 but illustrating an end of an acting finger sliding out of a depressed region;

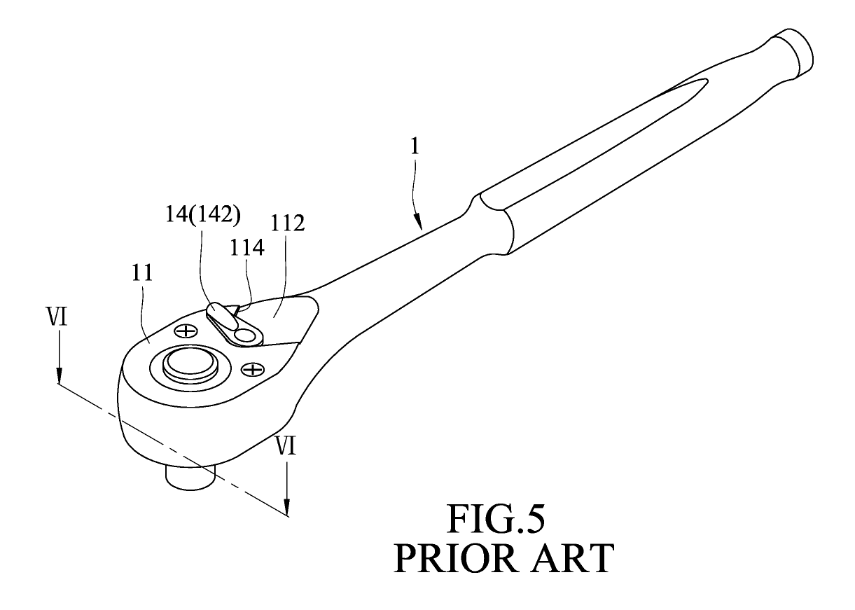

FIG. 6 is fragmentary cross-sectional view taken along line VI-VI of FIG. 5;

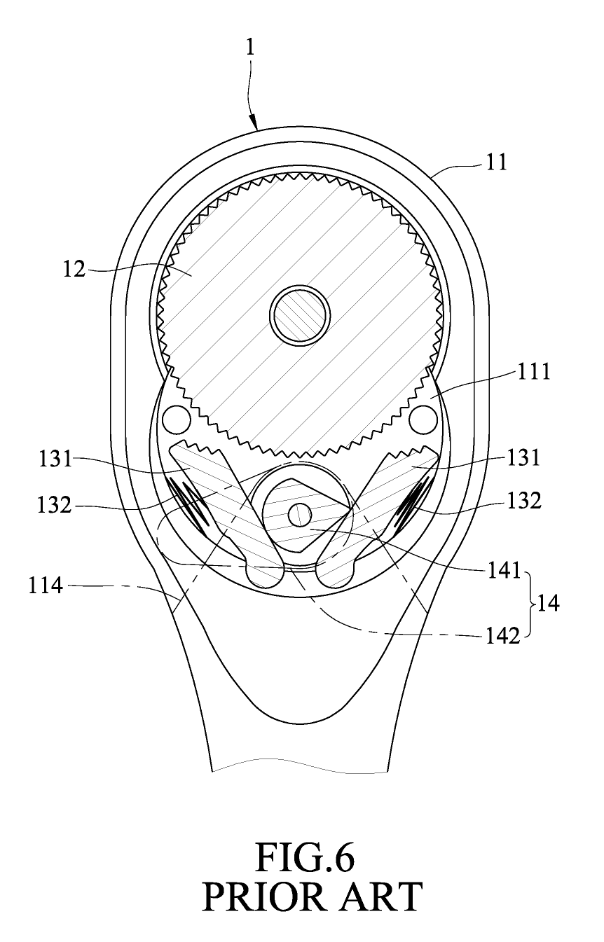

FIG. 7 is an exploded perspective view of a ratchet wrench according to a first embodiment of the disclosure;

FIG. 8 is fragmentary exploded perspective of the ratchet wrench in which a ratchet wheel, a driving member, and a pawl unit are omitted;

FIG. 9 is a fragmentary bottom view of the ratchet wrench of the first embodiment, in which a cover plate is omitted and a ratchet wheel can rotate only in a counterclockwise direction;

FIG. 10 is similar to FIG. 9 but illustrating the ratchet wheel can rotate only in a clockwise direction;

FIG. 11 is a fragmentary bottom view of a ratchet wrench according to a second embodiment of the disclosure, in which a cover plate is omitted and a ratchet wheel can rotate only in a counterclockwise direction;

FIG. 12 is similar to FIG. 11 but illustrating the ratchet wheel can rotate only in a clockwise direction;

FIG. 13 is fragmentary exploded plan view of a ratchet according to a third embodiment of the disclosure, illustrating an upper side of a head shell and a bottom side of a cam member;

FIG. 14 is a fragmentary bottom view of the ratchet wrench of the third embodiment, in which a cover plate is omitted and a ratchet wheel can rotate only in a counterclockwise direction;

FIG. 15 is similar to FIG. 14 but illustrating the ratchet wheel can rotate only in a clockwise direction;

FIG. 16 is fragmentary exploded perspective of a ratchet wrench according to a fourth embodiment in which a ratchet wheel, a driving member, and a pawl unit are omitted; and

FIG. 17 is a fragmentary exploded plan view of the ratchet wrench of the fourth embodiment, illustrating an upper side of a head shell and a bottom side of a cam member.

### DETAILED DESCRIPTION

Before the disclosure is described in greater detail, it should be noted that where considered appropriate, reference numerals have been repeated among the figures to indicate corresponding or analogous elements, which may optionally have similar characteristics.

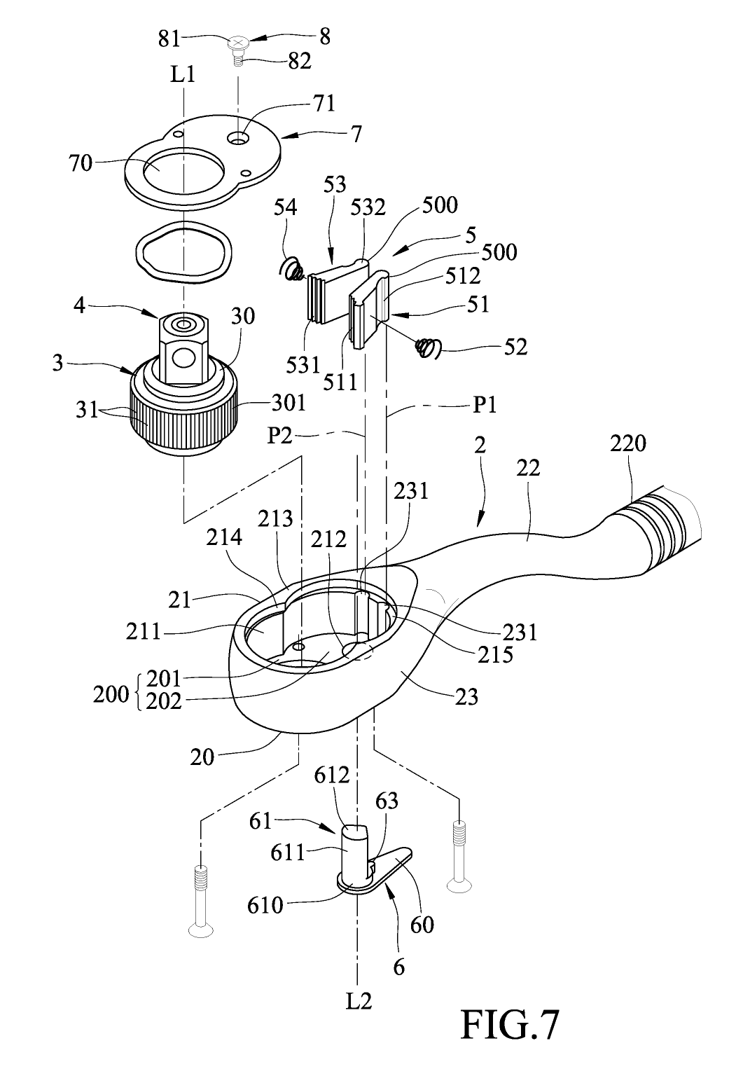

Referring to FIGS. 7 to 9, a ratchet wrench according to a first embodiment of the disclosure is shown to include a main body 2, a ratchet wheel 3, a driving member 4, a pawl unit 5, a cam member 61, an actuating finger 60, and a limiting member 6.

The main body 2 includes a head shell 21 and a handle 22.

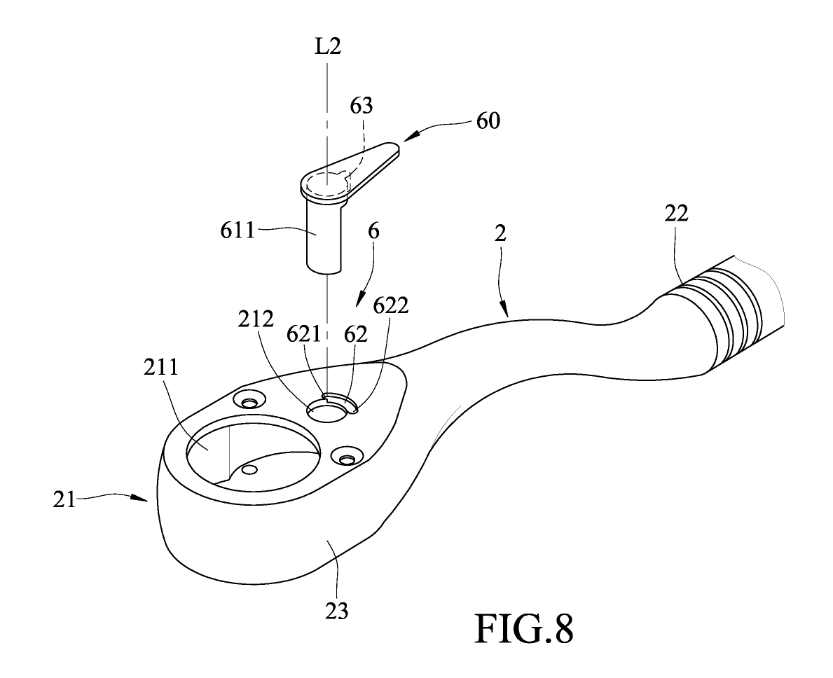

The head shell 21 defines therein an accommodation space 211, and has a through hole 212 which is configured to permit the accommodation space 211 to be in spatial communication with an exterior of the head shell 21. As shown in FIGS. 7 and 8, the head shell 21 includes an upper major wall 20 and a surrounding wall 23.

The upper major wall 20 has a major inner surface 200 including a primary region 201 and an auxiliary region 202. The primary region 201 defines a first axis (L1). The auxiliary region 202 has the through hole 212 which extends along a second axis (L2) offset from and parallel to the first axis (L1).

The surrounding wall 23 extends downwardly from a periphery of the major inner surface 200 to define the accommodation space 211.

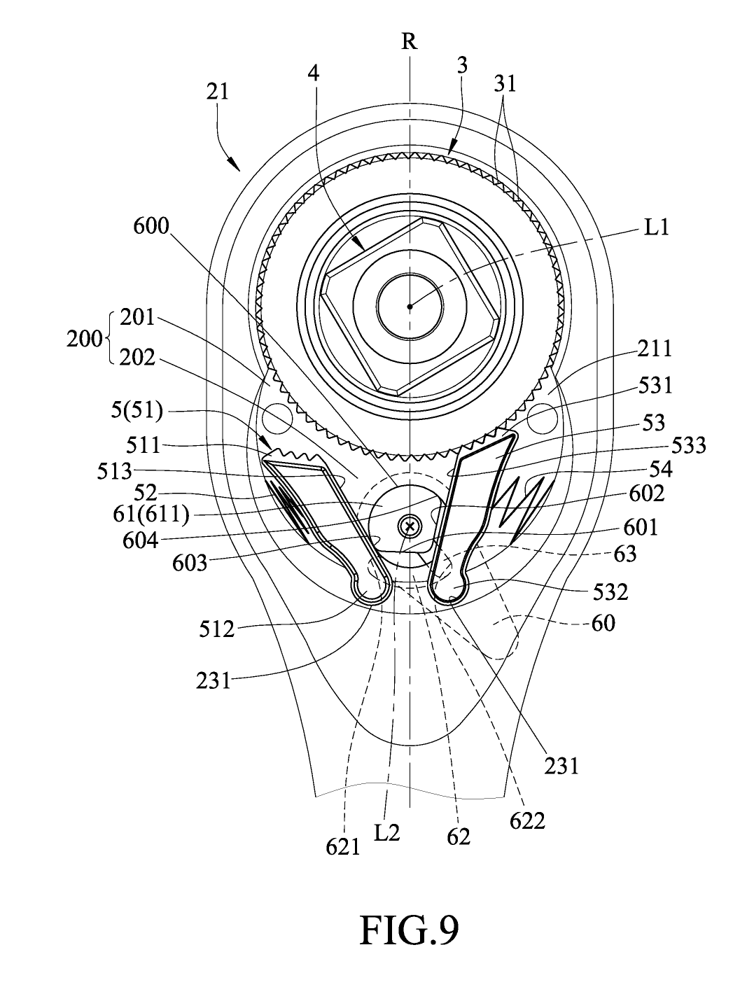

In this embodiment, as shown in FIGS. 7 and 9, an inner surface of the surrounding wall 23 is formed with two groove sockets 231 which are in proximity to the handle 22, and which are opposite to each other relative to a reference line (R) that is perpendicular to both the first and second axes (L1, L2).

Referring back to FIG. 7, it can be observed that the head shell 21 further includes a lower major wall 213 which is opposite to the upper major wall 20 in a direction of the first axis (L1) to enclose the accommodation space 211. The lower major wall 213 has an opening 214 configured to be slightly larger than the accommodation space 211, such that a seat shoulder 215 is formed between the lower major wall 213 and the inner surface of the surrounding wall 23.

The handle 22 extends radially from the surrounding wall 23 in proximity to the auxiliary region 202 to terminate at a handgrip 220.

The ratchet wheel 3 is rotatably mounted on the primary region 201 about the first axis (L1) in the accommodation space 211, and has a wheel body 30 and a rim surface 301 that has a plurality of teeth 31 angularly displaced from one another about the first axis (L1).

The driving member 4 extends downwardly from the wheel body 30 and out of the accommodation space 211 along the first axis (L1) to permit the ratchet wheel 3 to rotate with the driving member 4 about the first axis (L1). The driving member 4 is configured to mate with a screw (not shown), a nut (not shown), or the like.

The pawl unit 5 includes a first pawl member 51, a first biasing member 52, a second pawl member 53, and a second biasing member 54.

As shown in FIGS. 7 and 9, the first pawl member 51 is disposed on the auxiliary region 202 in the accommodation space 211, and includes a first pivot end 512, a first pawl end 511, and a first abutting region 513.

The first pivot end 512 is pivotable about a first pivot axis (P1) offset from the reference line (R) by a predetermined distance.

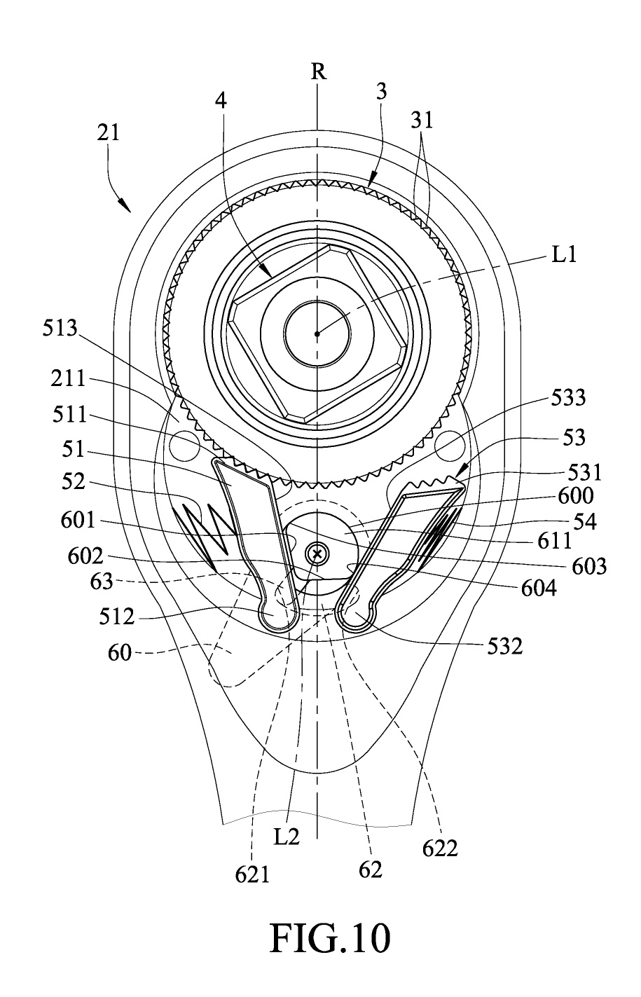

The first pawl end 511 is angularly movable between a first idle position and a first engaging position. In the first idle position, as shown in FIG. 9, the first pawl end 511 is spaced apart from the ratchet wheel 3. In the first engaging position, as shown in FIG. 10, the first pawl end 511 is in ratchet engagement with the ratchet wheel 3 to permit the ratchet wheel 3 to rotate in a clockwise direction only. In this embodiment, the first pawl end 511 has a saw-toothed edge configured to be brought into ratchet engagement with the ratchet wheel 3.

The first abutting region 513 is disposed between the first pivot end 512 and the first pawl end 511.

The first biasing member 52 is disposed to bias the first pawl end 511 to the first engaging position. In this embodiment, the first biasing member 52 is disposed between the surrounding wall 23 and the first pawl member 51, and is a compression spring.

The second pawl member 53 is disposed on the auxiliary region 202 in the accommodation space 211, and is opposite to the first pawl member 51 relative to the reference line (R). The second pawl member 53 includes a second pivot end 532, a second pawl end 531, and a second abutting region 533.

The second pivot end 532 is pivotable about a second pivot axis (P2) offset from the reference line (R) by the predetermined distance.

The second pawl end 531 is angularly movable between a second idle position and a second engaging position. In the second idle position, as shown in FIG. 10, the second pawl end 531 is spaced apart from the ratchet wheel 3. In the second engaging position, as shown in FIG. 9, the second pawl end 531 is in ratchet engagement with the ratchet wheel 3 to permit the ratchet wheel 3 to rotate in a counterclockwise direction only. In this embodiment, the second pawl end 531 has a saw-toothed edge configured to be brought into ratchet engagement with the ratchet wheel 3.

The second abutting region 533 is disposed between the second pivot end 532 and the second pawl end 531.

In this embodiment, as shown in FIG. 7, each of the first and second pivot ends 512, 532 has a rounded surface 500 which is configured to hingedly mounted in a corresponding one of the groove sockets 231 about a corresponding one of the first and second pivot axes (P1, P2).

The second biasing member 54 is disposed to bias the second pawl end 531 to the second engaging position. In this embodiment, the second biasing member 54 is disposed between the surrounding wall 23 and the second pawl member 53, and is a compression spring.

As shown in FIG. 7, the cam member 61 includes an upper end 610, a lower end 612, a cam body 611 disposed between the upper and lower ends 610, 612.

The upper end 610 extends outwardly of the through hole 212. The cam body 611 is disposed between the first and second pawl members 51, 53, and is pivotably mounted in the accommodation space 211 about the second axis (L2). The cam member 61 is angularly movable about the second axis (L2), and is configured such that when one of the first and second pawl ends 511, 531 is in ratchet engagement with the ratchet wheel 3, the other one of the first and second pawl ends 511, 531 is spaced apart from the ratchet wheel 3.

In this embodiment, the cam body 611 is disposed between the first and second abutting regions 513, 533, and is pivotably mounted about the second axis (L2) on the auxiliary region 202 in the accommodation space 211. As shown in FIG. 9, the cam body 611 has a camming surface 600, a first surface 601, and a second surface 602 which are angularly displaced from one another about the second axis (L2). Each of the first and second surfaces 601, 602 is offset from the second axis (L2) by a first distance, and the camming surface 600 is offset from the second axis (L2) by a second distance larger than the first distance. The cam member 61 is angularly movable about the second axis (L2) between a first position and a second position.

In the first position, as shown in FIG. 9, the camming surface 600 is in pressing engagement with the first abutting region 513 to force the first pawl end 511 to the first idle position against a biasing force of the first biasing member 52, while the second surface 602 confronts the second abutting region 533 to permit the second pawl end 531 in the second engaging position.

In the second position, as shown in FIG. 10, the camming surface 600 is in pressing engagement with the second abutting region 533 to force the second pawl end 531 to the second idle position against a biasing force of the second biasing member 54, while the first surface 601 confronts the first abutting region 513 to permit the first pawl end 511 in the first engaging position.

In this embodiment, the camming surface 600 has a first cam region 603 proximate to the first surface 601, and a second cam region 604 proximate to the second surface 602. The camming surface 600 is configured such that when the cam member 61 is in the first position (see FIG. 9), the first cam region 603 is brought into pressing engagement with the first abutting region 513, and such that when the cam member is in the second position (see FIG. 10), the second cam region 604 is brought into pressing engagement with the second abutting region 533.

As shown in FIGS. 7 and 8, the actuating finger 60 is coupled to the upper end 610 of the cam member 61 to turn the cam member 61 about the second axis (L2).

The limiting member 6 includes a key slot 62 formed in one of the actuating finger 60 and the upper major wall 20, and a key 63 which is slidably engaged in the key slot 62, and which is formed in the other one of the actuating finger 60 and the upper major wall 20 so as to restrict angular movement of the actuating finger 60.

In this embodiment, the key slot 62 extends angularly about the second axis (L2) to terminate at a first edge 621 and a second edge 622.

In this embodiment, when the actuating finger 60 is turned clockwise to move the cam member 61 to the second position (FIG. 10), the key 63 is brought into blocking engagement with the first edge 621. When the actuating finger 60 is turned counterclockwise to move the cam member 61 to the first position (FIG. 9), the second edge 622 is in blocking engagement with the key 63.

In this embodiment, the key slot 62 is formed in the upper major wall 20 proximate to the through hole 212, and may have a depth greater than 1 mm. The key 63 is formed in the actuating finger 60, and has a length in a direction of the second axis (L2), which may be greater than 1 mm. The key slot 62 may have a depth greater than 2 mm or 3 mm, and the key 63 may have a length in the direction of the second axis (L2) greater than 2 mm or 3 mm. In this embodiment, the key slot 62 has a depth of 3.5 mm, and the key 63 has a length of 3 mm in the direction of the second axis (L2).

Furthermore, the actuating finger 60 is configured to always cover the key slot 62 during the angular movement of the actuating finger 60.

In this embodiment, as shown in FIG. 7, the ratchet wrench further includes a cover plate 7 and a screw member 8.

The cover plate 7 is configured to be fitted in the opening 214 so as to be in abutment engagement with the seat shoulder 215. In addition, the cover plate 7 has a through bore 70 configured to permit the driving member 4 to extend therethrough, and a passage hole 71 extending along the second axis (L2).

The screw member 8 has an enlarged head 81 and a male threaded portion 82. The enlarged head 81 has a dimension larger than the passing hole 71, and is disposed outwardly of the cover plate 7. The male threaded portion 82 extends through the passage hole 71 and is configured to be brought into threaded engagement with a female threaded portion (not shown) formed in the lower end 612 of the cam body 611 so as to permit the screw member 8 to retain the cam member 61 and to turn with the cam member 61 about the second axis (L2).

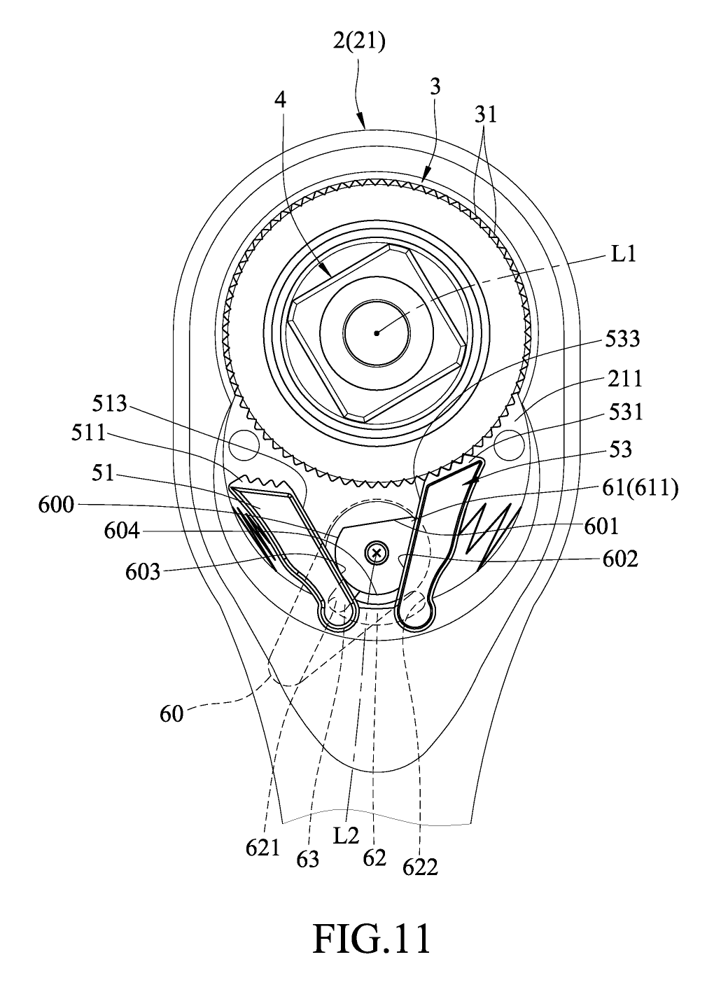

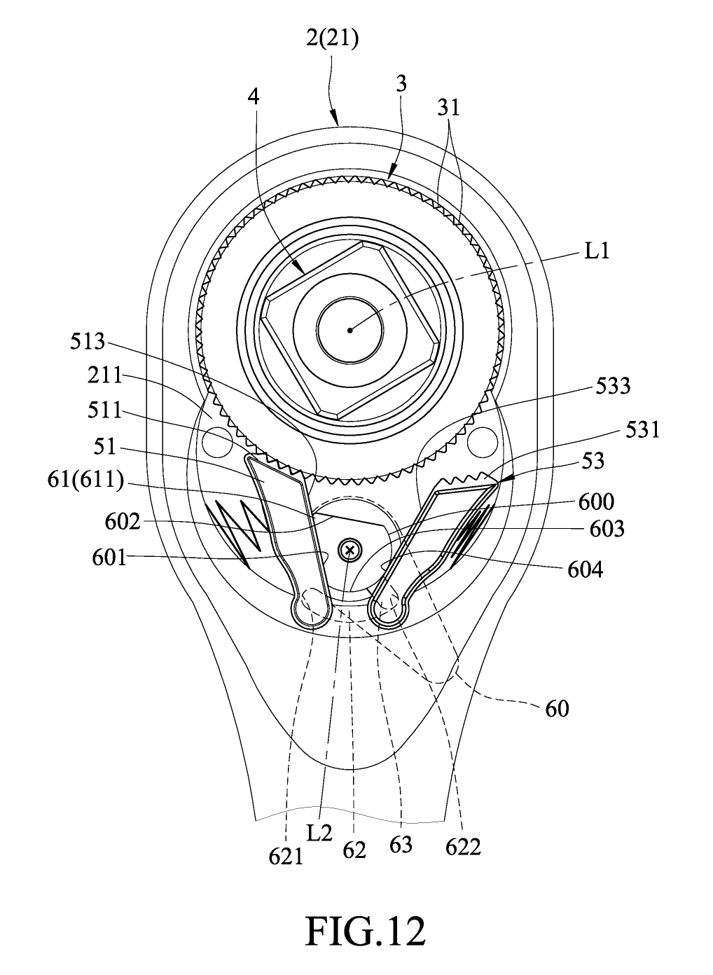

FIGS. 11 and 12 illustrate a ratchet wrench according to a second embodiment of the disclosure. The second embodiment is similar to the first embodiment, except that the configuration of the cam body 611 of the second embodiment is different from that of the first embodiment, i.e., the first and second surfaces 601, 602 of the cam body 611 are disposed more closely to the ratchet wheel 3.

Therefore, when the actuating finger 60 is turned clockwise to move the cam member 61 to the first position, as shown in FIG. 11, the key 63 is brought into blocking engagement with the first edge 621. When the actuating finger 60 is turned counterclockwise to move the cam member 61 to the second position, as shown in FIG. 12, the key 63 is brought into blocking engagement with the second edge 622.

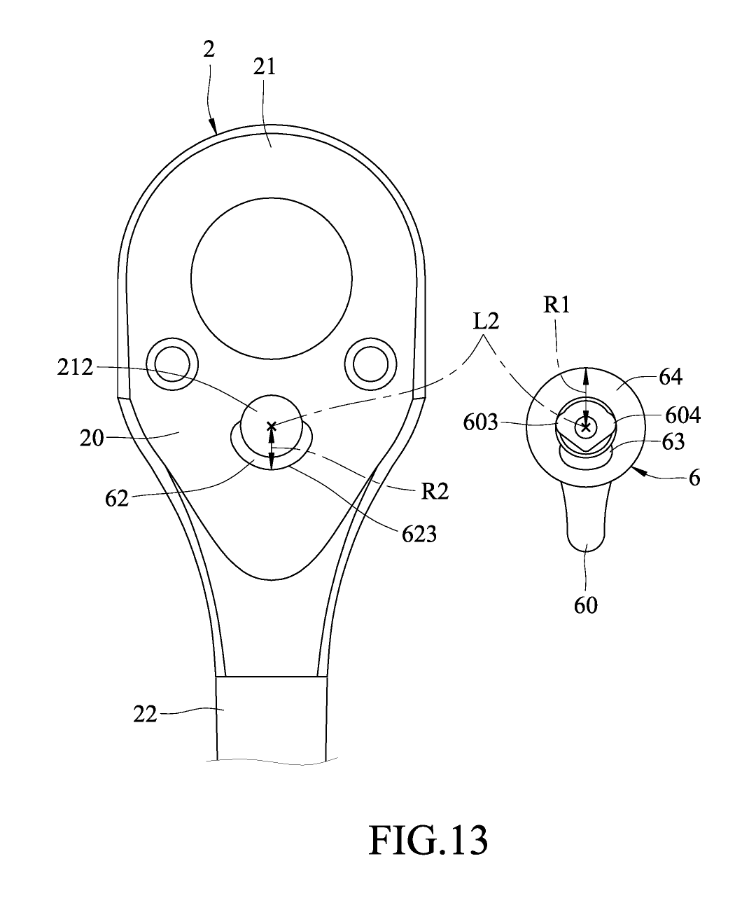

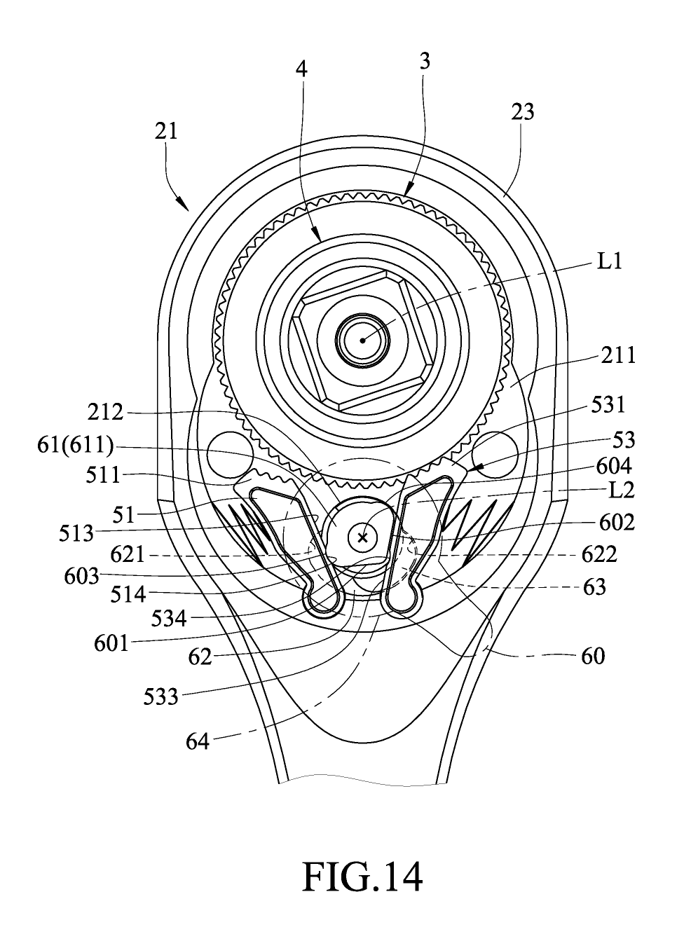

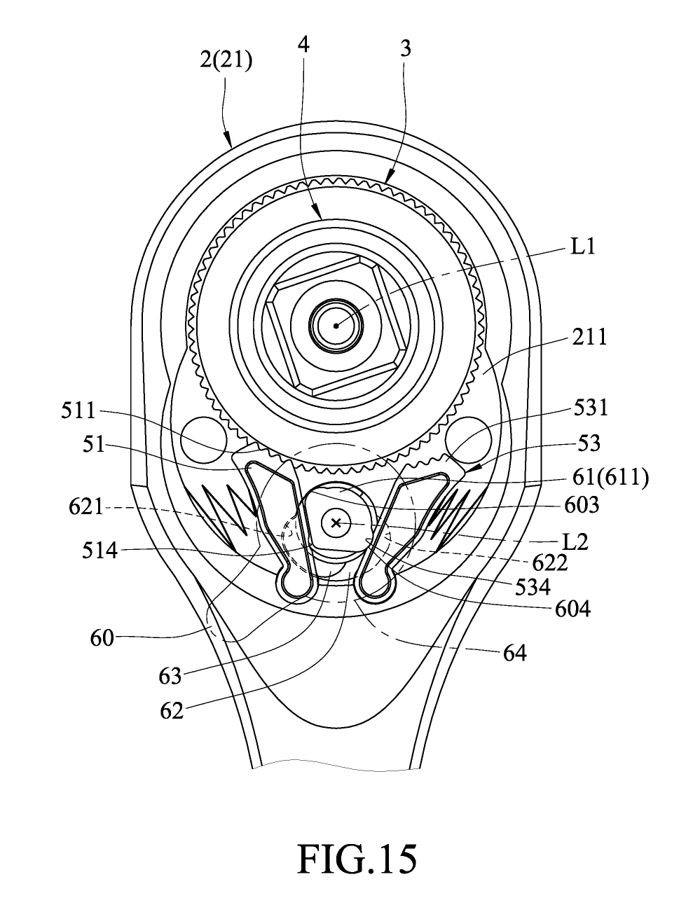

FIGS. 13 to 15 illustrate a ratchet wrench according to a third embodiment of the disclosure. The third embodiment is similar to the first embodiment, except that in this embodiment, the first abutting region 513 has a first mating area 514 and the second abutting region 533 has a second mating area 534. The first mating area 514 is configured to permit the first cam region 603 to be brought into interference engagement with the first mating area 514 when the cam member 61 is in the first position (FIG. 14). The second mating area 534 is configured to permit the second cam region 604 to be brought into interference engagement with the second mating area 534 when the cam member 61 is in the second position (FIG. 15).

Furthermore, the key slot 62 extends angularly about the second axis (L2) for a first arc length, and the key 63 extends angularly about the second axis (L2) for a second arc length. A ratio of the first arc length to the second arc length ranges from 2:1 to 4:1. In the case, the angular movement of the cam member 61 may be more smoothly.

Moreover, the actuating finger 60 has a disc-shaped coupling end 64 which is coupled to the upper end 610 of the cam member 61, and which extends radially from the second axis (L2) to have a first radius (R1). The key slot 62 has an angular edge 623 which extends about the second axis (L2), and which is most distal from the second axis (L2). A distance (R2) between the angular edge 623 and the second axis (L2) is smaller than the first radius (R1) so as to prevent small particles from falling into the key slot 62.

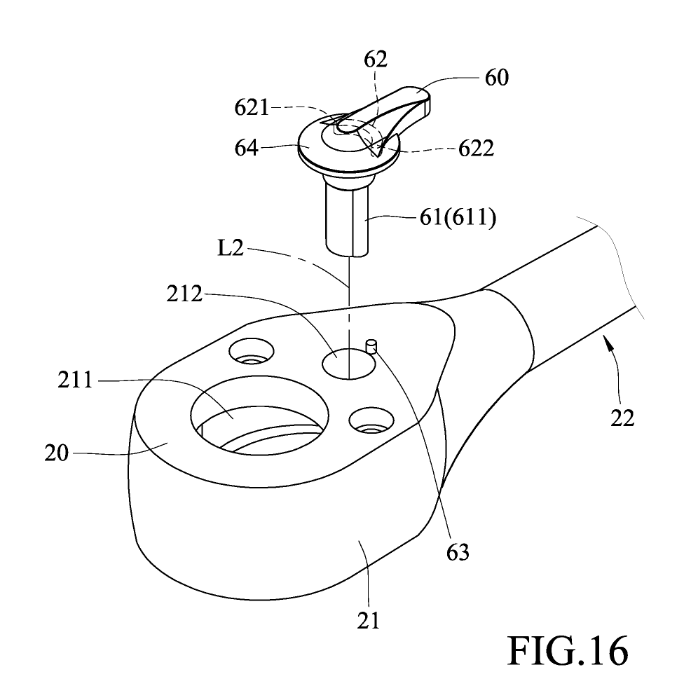

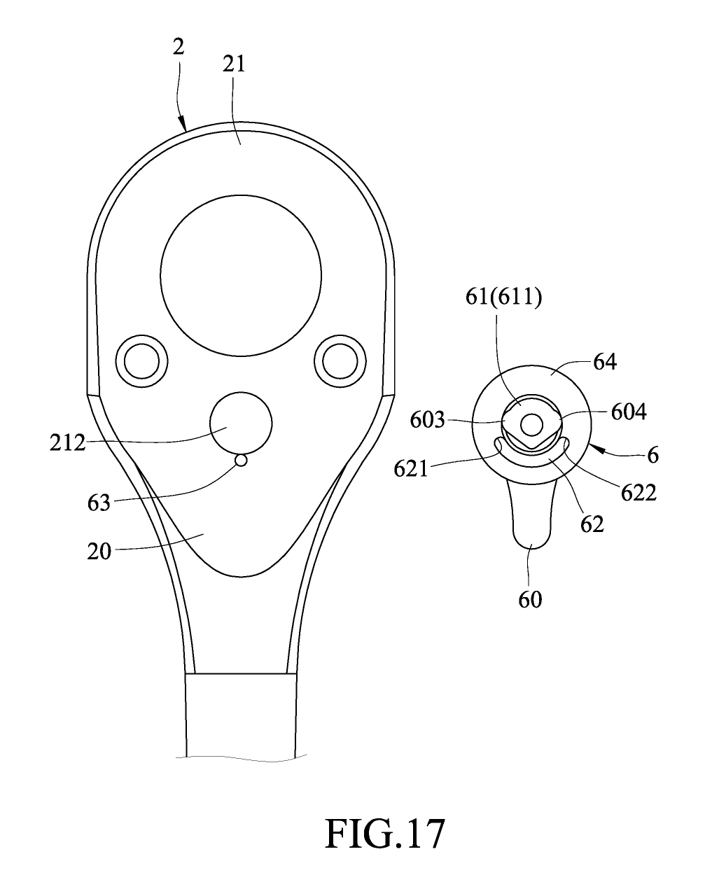

FIGS. 16 and 17 illustrate a ratchet wrench according to a fourth embodiment of the disclosure. The fourth embodiment is similar to the third embodiment, except that in this embodiment, the key slot 62 is formed in the actuating finger 60 proximate to the cam member 61, and the key 63 is formed in the upper major wall 20.

The key slot 62 may have a depth ranging from 2 mm to 3 mm. In this embodiment, the key slot 62 has a depth of 2.5 mm, and the key 63 has a height of about 2.5 mm from an outer surface of the upper major wall 20 in the direction of the second axis (L2).

Before mounting the key 63 on the head shell 21, a key hole (not shown) is previously formed in the upper major wall 20 adjacent to the through hole 212. Then, a bottom end of the key 63 is inserted and secured in the key hole to leave a top end of the key 63 on the upper major wall 20. The key slot 62 is formed in a lower surface of the disc-shaped coupling end 64 using a milling process.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A ratchet wrench comprising:
a head shell including an upper major wall having a through hole, and a surrounding wall extending downwardly from a periphery of said upper major wall to define an accommodation space;
a ratchet wheel which is rotatably mounted in said accommodation space about a first axis, and including a plurality of teeth angularly displaced from one another about the first axis;
a first pawl member including a first pivot end which is pivotally mounted in said accommodation space, and a first pawl end which is angularly movable between a first idle position, where said first pawl end is spaced apart from said ratchet wheel, and a first engaging position, where said first pawl end is in ratchet engagement with said ratchet wheel to permit said ratchet wheel to rotate in a clockwise direction only;
a first biasing member disposed to bias said first pawl end to the first engaging position;
a second pawl member opposite to said first pawl member, and including a second pivot end which is pivotally mounted in said accommodation space, and a second pawl end which is angularly movable between a second idle position, where said second pawl end is spaced apart from said ratchet wheel, and a second engaging position, where said second pawl end is in ratchet engagement with said ratchet wheel to permit said ratchet wheel to rotate in a counterclockwise direction only;
a second biasing member disposed to bias said second pawl end to the second engaging position;
a cam member including an upper end extending outwardly of said through hole, and a cam body which is disposed between said first and second pawl members, and which is pivotably mounted in said accommodation space about a second axis that is offset from and parallel to the first axis, said cam member being angularly movable about the second axis, and being configured such that when one of said first and second pawl ends is in ratchet engagement with said ratchet wheel, the other one of said first and second pawl ends is spaced apart from said ratchet wheel;
an actuating finger coupled to said upper end of said cam member to turn said cam member about the second axis; and
a limiting member including a key slot formed in one of said actuating finger and said upper major wall, and a key which is slidably engaged in said key slot, and which is formed in the other one of said actuating finger and said upper major wall so as to restrict angular movement of said actuating finger.

2. The ratchet wrench according to claim 1, wherein:
said upper major wall includes a major inner surface having a primary region which defines the first axis, and an auxiliary region which has said through hole extending along the second axis;
said surrounding wall extends downwardly from a periphery of said major inner surface to define said accommodation space;
said ratchet wheel is rotatably mounted on said primary region about the first axis in said accommodation space, and has a wheel body and a rim surface with said teeth;
said first pawl member is disposed on said auxiliary region in said accommodation space, and said first pivot end is pivotable about a first pivot axis offset from a reference line which is perpendicular to both the first and second axes by a predetermined distance, said first pawl member further including a first abutting region disposed between said first pivot end and said first pawl end;
said second pawl member is disposed on said auxiliary region in said accommodation space, and is opposite to said first pawl member relative to the reference line, said second pivot end being pivotable about a second pivot axis offset from the reference line by said predetermined distance, said second pawl member further including a second abutting region disposed between said second pivot end and said second pawl end; and
said cam body is disposed between said first and second abutting regions, and is pivotably mounted about the second axis on said auxiliary region in said accommodation space, said cam body having a camming surface, a first surface, and a second surface which are angularly displaced from one another about the second axis, each of said first and second surfaces being offset from the second axis by a first distance, said camming surface being offset from the second axis by a second distance larger than the first distance, said cam member being angularly movable about the second axis between
(i) a first position, where said camming surface is in pressing engagement with said first abutting region to force said first pawl end to the first idle position against a biasing force of said first biasing member, while said second surface confronts said second abutting region to permit said second pawl end in the second engaging position, and
(ii) a second position, where said camming surface is in pressing engagement with said second abutting region to force said second pawl end to the second idle position against a biasing force of said second biasing member, while said first surface confronts said first abutting region to permit said first pawl end in the first engaging position, said ratchet wrench further comprising:
a handle extending radially from said surrounding wall in proximity to said auxiliary region to terminate at a handgrip; and
a driving member extending downwardly from said wheel body and out of said accommodation space along the first axis to permit said ratchet wheel to rotate with said driving member about the first axis.

3. The ratchet wrench according to claim 2, wherein:
an inner surface of said surrounding wall is formed with two groove sockets which are in proximity to said handle, and which are opposite to each other relative to the reference line, each of said first and second pivot ends having a rounded surface which is configured to hingedly mounted in a corresponding one of said groove sockets about a corresponding one of the first and second pivot axes; and
said head shell further includes a lower major wall which is opposite to said upper major wall in a direction of the first axis to enclose said accommodation space, and which has an opening configured to be slightly larger than said accommodation space, such that a seat shoulder is formed between said lower major wall and said inner surface of said surrounding wall, said ratchet wrench further comprising
a cover plate which is configured to be fitted in said opening so as to be in abutment engagement with said seat shoulder, and which has a through bore configured to permit said driving member to extend therethrough.

4. The ratchet wrench according to claim 2, wherein said key slot extends angularly about the second axis to terminate at a first edge and a second edge.

5. The ratchet wrench according to claim 4, wherein said cam body is configured such that said key is brought into blocking engagement with said first edge when said actuating finger is turned clockwise to move said cam member to the second position, and such that said key is brought into blocking engagement with said second edge when said actuating finger is turned counterclockwise to move said cam member to the first position.

6. The ratchet wrench according to claim 4, wherein said cam body is configured such that said key is brought into blocking engagement with said first edge when said actuating finger is turned clockwise to move said cam member to the first position, and such that said key is brought into blocking engagement with said second edge when said actuating finger is turned counterclockwise to move said cam member to the second position.

7. The ratchet wrench according to claim 4, wherein said key slot is formed in said actuating finger proximate to said cam member, and said key is formed in said upper major wall.

8. The ratchet wrench according to claim 4, wherein said key slot is formed in said upper major wall proximate to said through hole, and said key is formed in said actuating finger.

9. The ratchet wrench according to claim 8, wherein said key slot extends angularly about the second axis for a first arc length, and said key extends angularly about the second axis for a second arc length, a ratio of the first arc length to the second arc length ranging from 2:1 to 4:1.

10. The ratchet wrench according to claim 8, wherein said actuating finger is configured to always cover said key slot during the angular movement of said actuating finger.

11. The ratchet wrench according to claim 2, wherein said camming surface has a first cam region proximate to said first surface, and a second cam region proximate to said second surface, said camming surface being configured such that when said cam member is in the first position, said first cam region is brought into pressing engagement with said first abutting region, and such that when said cam member is in the second position, said second cam region is brought into pressing engagement with said second abutting region.

12. The ratchet wrench according to claim 11, wherein said first abutting region has a first mating area configured to permit said first cam region to be brought into interference engagement with said first mating area when said cam member is in the first position, and said second abutting region has a second mating area configured to permit said second cam region to be brought into interference engagement with said second mating area when said cam member is in the second position.

13. The ratchet wrench according to claim 1, wherein said key slot has a depth greater than 1 mm, and said key has a length in a direction of the second axis, which is greater than 1 mm.

14. A ratchet wrench comprising:
a head shell including
an upper major wall with a major inner surface having a primary region which defines a first axis, and an auxiliary region which has a through hole extending along a second axis offset from and parallel to the first axis, and
a surrounding wall extending downwardly from a periphery of said major inner surface to define an accommodation space;
a handle extending radially from said surrounding wall in proximity to said auxiliary region to terminate at a handgrip;
a ratchet wheel which is rotatably mounted on said primary region about the first axis in said accommodation space, and which has a wheel body and a rim surface that has a plurality of teeth angularly displaced from one another about the first axis;
a driving member extending downwardly from said wheel body and out of said accommodation space along the first axis to permit said ratchet wheel to rotate with said driving member about the first axis;
a first pawl member disposed on said auxiliary region in said accommodation space, and including
a first pivot end which is pivotable about a first pivot axis offset from a reference line that is perpendicular to both the first and second axes by a predetermined distance,
a first pawl end which is angularly movable between a first idle position, where said first pawl end is spaced apart from said ratchet wheel, and a first engaging position, where said first pawl end is in ratchet engagement with said ratchet wheel to permit said ratchet wheel to rotate in a clockwise direction only, and
a first abutting region disposed between said first pivot end and said first pawl end;
a first biasing member disposed to bias said first pawl end to the first engaging position;
a second pawl member which is disposed on said auxiliary region in said accommodation space, and which is opposite to said first pawl member relative to the reference line, said second pawl member including
a second pivot end which is pivotable about a second pivot axis offset from the reference line by said predetermined distance,
a second pawl end which is angularly movable between a second idle position, where said second pawl end is spaced apart from said ratchet wheel, and a second engaging position, where said second pawl end is in ratchet engagement with said ratchet wheel to permit said ratchet wheel to rotate in a counterclockwise direction only, and
a second abutting region disposed between said second pivot end and said second pawl end;
a second biasing member disposed to bias said second pawl end to the second engaging position;
a cam member including an upper end extending outwardly of said through hole, and a cam body which is disposed between said first and second abutting regions, and which is pivotably mounted about the second axis on said auxiliary region in said accommodation space, said cam body having a camming surface, a first surface, and a second surface which are angularly displaced from one another about the second axis, each of said first and second surfaces being offset from the second axis by a first distance, said camming surface being offset from the second axis by a second distance larger than the first distance, said cam member being angularly movable about the second axis between
(i) a first position, where said camming surface is in pressing engagement with said first abutting region to force said first pawl end to the first idle position against a biasing force of said first biasing member, while said second surface confronts said second abutting region to permit said second pawl end in the second engaging position, and
(ii) a second position, where said camming surface is in pressing engagement with said second abutting region to force said second pawl end to the second idle position against a biasing force of said second biasing member, while said first surface confronts said first abutting region to permit said first pawl end in the first engaging position;
an actuating finger coupled to said upper end of said cam member to turn said cam member about the second axis; and
a limiting member including a key slot formed in one of said actuating finger and said upper major wall, and a key which is slidably engaged in said key slot, and which is formed in the other one of said actuating finger and said upper major wall so as to restrict angular movement of said actuating finger.
